(19) United States
(12) Patent Application Publication
(10) Pub. No.: US 2026/0335722 A1
(43) Pub. Date: Oct. 29, 2026

(54) PORTABLE BOWLING BALL CUP ASSEMBLY

(71) Applicant: Antany D. Peppers, Columbus, OH (US)

(72) Inventor: Antany D. Peppers, Columbus, OH (US)

(21) Appl. No.: 19/380,764

(22) Filed: Nov. 5, 2025

Related U.S. Application Data
(60) Provisional application No. 63/794,516, filed on Apr. 25, 2025.
(60) Provisional application No. 63/794,507, filed on Apr. 25, 2025.
(60) Provisional application No. 63/794,494, filed on Apr. 25, 2025.

(51) Int. Cl. A63B 47/00

(52) U.S. Cl. CPC A63B 47/007; A63B 2210/50; A63B 2225/093

(57) ABSTRACT

The present disclosure provides a bowling ball support assembly comprising a lower member assembly, an intermediate member assembly, and an upper member assembly. Each assembly includes a lateral support beam having first and second ends, and roller support platforms disposed at the first and second ends of the lateral support beam. The lower member assembly, intermediate member assembly, and upper member assembly are configured to interconnect to form a stable support structure. Roller ball bearing assemblies are mounted on the roller support platforms and arranged in a radial pattern to support a bowling ball in a rotational manner. The assemblies are designed to interconnect in a puzzle-like configuration without the use of tools, allowing for easy assembly and disassembly. The roller ball bearing assemblies are positioned at an inward angle towards the center of the support assembly to provide balanced support for the bowling ball.

### RELATED APPLICATIONS

This application claims the benefit of U.S. Provisional Patent Application Nos. 63/794,494, 63/794,507, and 63/794,516, filed on Apr. 25, 2025, which are incorporated herein by reference in their entirety.

### FIELD OF THE INVENTION

The present disclosure relates to bowling ball support devices, and more particularly to a collapsible bowling ball cup with interlocking components that can be easily disassembled for storage and transport.

### BACKGROUND

Bowling is a popular recreational activity enjoyed by millions of people worldwide. The sport involves rolling a heavy ball down a lane to knock over a set of pins. A key piece of equipment used in bowling is the bowling ball, which typically weighs between 6 to 16 pounds and has a smooth, spherical surface with finger holes drilled into it.

When not in use during play, bowling balls need to be properly supported and stored to prevent damage and maintain their condition. Traditionally, bowling balls have been placed on flat surfaces or in bags, which can lead to scratches, dents, or deformation of the ball over time. Additionally, bowlers often need to transport their balls to and from bowling alleys or tournaments.

Various devices have been developed to support and display bowling balls when not in active use. These include stationary ball stands, racks, and cups designed to cradle the spherical shape of the ball. However, many existing support devices are bulky, difficult to transport, or do not adequately protect the ball's surface.

There is an ongoing need for improved bowling ball support solutions that can securely hold the ball while also being portable and easy to use. Ideally, such a device would allow for convenient storage and transport of the bowling ball without compromising its protective function. Additionally, a support that enables rotation of the ball for inspection, cleaning, or maintenance purposes could provide added utility for bowlers.

As the sport of bowling continues to evolve, so too does the equipment used by players. Advancements in bowling ball technology, including new core designs and coverstock materials, have led to changes in how balls perform and how they should be cared for. This creates opportunities for innovation in complementary products like ball supports and storage devices.

Developing bowling equipment that enhances the player experience while also being practical remains an area of interest in the industry. Solutions that can meet the needs of casual bowlers and competitive players alike have the potential to gain widespread adoption and improve the overall bowling experience.

### SUMMARY

The present disclosure provides a bowling ball support assembly that may address the various challenges associated with supporting, storing, and transporting bowling balls. In some aspects, the bowling ball support assembly may comprise multiple interconnected member assemblies that form a stable support structure with roller ball bearing assemblies arranged in a radial pattern. The assembly may be designed to provide secure support for a bowling ball while allowing for rotational movement, which may facilitate inspection, cleaning, and maintenance activities. The modular design may enable the assembly to be easily disassembled for compact storage and transport, potentially making it suitable for both casual and competitive bowlers who require portable ball support solutions.

Some exemplary embodiments are related to a bowling ball support assembly. The bowling ball support assembly comprises a first member assembly comprising a first lateral support beam having first and second ends. The bowling ball support assembly comprises a second member assembly comprising a second lateral support beam having first and second ends. The bowling ball support assembly comprises a third member assembly comprising a third lateral support beam having first and second ends. The first member assembly, second member assembly, and third member assembly are configured to interconnect to form a stable support structure. The bowling ball support assembly comprises a plurality of roller ball bearing assemblies mounted on the first and second ends of the lateral support beams and arranged in a radial pattern to support a bowling ball.

Other exemplary embodiments are related to a collapsible bowling ball support assembly. The collapsible bowling ball support assembly comprises a lower member assembly having a lateral support beam with an upper shaped connecting notch and roller support platforms at opposing ends. The collapsible bowling ball support assembly comprises an intermediate member assembly having a lateral support beam with an upper shaped connecting notch and a lower shaped connecting notch and roller support platforms at opposing ends. The collapsible bowling ball support assembly comprises an upper member assembly having a lateral support beam with a lower shaped connecting notch and roller support platforms at opposing ends. The shaped connecting notches are configured to engage with each other in a puzzle-like configuration to interconnect the assemblies without tools. The collapsible bowling ball support assembly comprises roller ball bearing assemblies mounted on each roller support platform, each roller ball bearing assembly comprising a roller ball disposed at an inward angle towards a center of the bowling ball support assembly.

Still further exemplary embodiments are related to a portable bowling ball support assembly. The portable bowling ball support assembly comprises a lower member assembly comprising a lateral support beam having an upper shaped connecting notch defined by first and second shaped walls, and roller support platforms at first and second ends of the lateral support beam. The portable bowling ball support assembly comprises an intermediate member assembly comprising a lateral support beam having an upper shaped connecting notch defined by first and second shaped walls and a lower shaped connecting notch defined by third and fourth shaped walls, and roller support platforms at first and second ends of the lateral support beam. The portable bowling ball support assembly comprises an upper member assembly comprising a lateral support beam having a lower shaped connecting notch defined by first and second shaped walls, and roller support platforms at first and second ends of the lateral support beam. The portable bowling ball support assembly comprises six roller ball bearing assemblies, each comprising a roller ball and mounted on a respective roller support platform at an inward angle of approximately 25 degrees towards a center of the assembly. The upper shaped connecting notch of the lower member assembly engages with the lower shaped connecting notch of the intermediate member assembly, and the upper shaped connecting notch of the intermediate member assembly engages with the lower shaped connecting notch of the upper member assembly to form a stable six-point radial support structure with roller balls spaced at approximately 60-degree intervals.

The bowling ball support assembly may provide enhanced functionality through its modular design and rotational capabilities. In some aspects, the assembly may allow users to easily rotate a supported bowling ball for comprehensive inspection, cleaning, or maintenance without requiring removal of the ball from the support structure. The collapsible nature of the assembly may facilitate convenient storage and transport, while the tool-free assembly process may enable quick setup and breakdown as needed. These features may collectively address the various needs of bowlers who require portable, versatile, and reliable ball support solutions.

### BRIEF DESCRIPTION OF FIGURES

FIG. 1 illustrates a perspective view of a bowling ball support assembly, according to aspects of the present disclosure.

FIG. 2 depicts a bottom perspective view of the bowling ball support assembly of FIG. 1, according to aspects of the present disclosure.

FIG. 3 shows a top plan view of the bowling ball support assembly of FIG. 1, according to aspects of the present disclosure.

FIG. 4 presents a bottom view of the bowling ball support assembly of FIG. 1, according to aspects of the present disclosure.

FIG. 5 illustrates a side elevation view of the bowling ball support assembly of FIG. 1, according to aspects of the present disclosure.

FIG. 6 depicts multiple perspective views showing connection arrangements of the bowling ball support assembly, according to aspects of the present disclosure.

FIG. 7 shows a side exploded view of roller ball bearing assemblies and an intermediate member assembly, according to aspects of the present disclosure.

FIG. 8 illustrates a perspective view of a lower member assembly with roller ball bearing assemblies, according to aspects of the present disclosure.

FIG. 9 depicts a perspective view of the lower member assembly of FIG. 8, according to aspects of the present disclosure.

FIG. 10 presents a top view of the lower member assembly of FIG. 8, according to aspects of the present disclosure.

FIG. 11 shows a bottom view of the lower member assembly of FIG. 8, according to aspects of the present disclosure.

FIG. 12A illustrates a top plan view of the lower member assembly with dimensional indicators, according to aspects of the present disclosure.

FIG. 12B depicts a side elevation view of the lower member assembly with dimensional indicators, according to aspects of the present disclosure.

FIG. 12C shows a side elevation sectional view of the bowling ball support assembly, according to aspects of the present disclosure.

FIG. 13 illustrates a perspective view of an intermediate member assembly with roller ball bearing assemblies, according to aspects of the present disclosure.

FIG. 14 depicts a bottom perspective view of the intermediate member assembly of FIG. 13, according to aspects of the present disclosure.

FIG. 15 presents a top view of the intermediate member assembly of FIG. 13, according to aspects of the present disclosure.

FIG. 16 shows a bottom view of the intermediate member assembly of FIG. 13, according to aspects of the present disclosure.

FIG. 17 illustrates a side elevation view of the intermediate member assembly of FIG. 13, according to aspects of the present disclosure.

FIG. 18 depicts a perspective view of an upper member assembly with roller ball bearing assemblies, according to aspects of the present disclosure.

FIG. 19 shows a side view of the upper member assembly of FIG. 18, according to aspects of the present disclosure.

FIG. 20 presents a top view of the upper member assembly of FIG. 18, according to aspects of the present disclosure.

FIG. 21 illustrates a bottom view of the upper member assembly of FIG. 18, according to aspects of the present disclosure.

FIG. 22 depicts a front elevation view of the upper member assembly of FIG. 18, according to aspects of the present disclosure.

FIG. 23 shows a top perspective view of an alternative bowling ball support assembly, according to aspects of the present disclosure.

FIG. 24 illustrates a bottom perspective view of the alternative bowling ball support assembly of FIG. 23, according to aspects of the present disclosure.

FIG. 25 depicts a top plan view of the alternative bowling ball support assembly of FIG. 23, according to aspects of the present disclosure.

FIG. 26 shows a top view of the alternative bowling ball support assembly of FIG. 23, according to aspects of the present disclosure.

FIG. 27 presents a side elevation view of the alternative bowling ball support assembly of FIG. 23, according to aspects of the present disclosure.

FIG. 28 illustrates a top perspective view of the alternative bowling ball support assembly with detailed roller ball bearing assemblies, according to aspects of the present disclosure.

FIG. 29 depicts an exploded perspective view of an intermediate member assembly with detailed roller ball bearing assemblies, according to aspects of the present disclosure.

FIG. 30 shows a top perspective view of a lower member assembly of the alternative bowling ball support assembly, according to aspects of the present disclosure.

FIG. 31 illustrates a bottom perspective view of the lower member assembly of FIG. 30, according to aspects of the present disclosure.

FIG. 32 depicts a top plan view of the lower member assembly of FIG. 30, according to aspects of the present disclosure.

FIG. 33 shows a bottom plan view of the lower member assembly of FIG. 30, according to aspects of the present disclosure.

FIG. 34A illustrates a side elevation view of the lower member assembly of the alternative bowling ball support assembly, according to aspects of the present disclosure.

FIG. 34B depicts a side elevation view of the lower member assembly with dimensional indicators, according to aspects of the present disclosure.

FIG. 34C shows a side elevation sectional view of the alternative bowling ball support assembly, according to aspects of the present disclosure.

FIG. 35 illustrates a top perspective view of an intermediate member assembly of the alternative bowling ball support assembly, according to aspects of the present disclosure.

FIG. 36 depicts a bottom perspective view of the intermediate member assembly of FIG. 35, according to aspects of the present disclosure.

FIG. 37 shows a top plan view of the intermediate member assembly of FIG. 35, according to aspects of the present disclosure.

FIG. 38 illustrates a bottom plan view of the intermediate member assembly of FIG. 35, according to aspects of the present disclosure.

FIG. 39 depicts a side elevation view of the intermediate member assembly of FIG. 35, according to aspects of the present disclosure.

FIG. 40 shows a top perspective view of an upper member assembly of the alternative bowling ball support assembly, according to aspects of the present disclosure.

FIG. 41 illustrates a bottom perspective view of the upper member assembly of FIG. 40, according to aspects of the present disclosure.

FIG. 42 depicts a top plan view of the upper member assembly of FIG. 40, according to aspects of the present disclosure.

FIG. 43 shows a bottom plan view of the upper member assembly of FIG. 40, according to aspects of the present disclosure.

FIG. 44 illustrates a side elevation view of the upper member assembly of FIG. 40, according to aspects of the present disclosure.

FIG. 45 depicts a perspective view of a bowling ball supported on the bowling ball support assembly of FIG. 1, according to aspects of the present disclosure.

FIG. 46 shows a perspective view of a bowling ball supported on the alternative bowling ball support assembly of FIG. 23, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The bowling ball support assembly may provide a stable and versatile platform for supporting, inspecting, and maintaining bowling balls. In some aspects, the support assembly may allow for easy rotation of the bowling ball while it remains securely cradled. This rotational capability may enable users to access all areas of the ball's surface without the need for lifting or repositioning. The support assembly may facilitate thorough cleaning and maintenance procedures by allowing the ball to be rotated in place. Users may apply cleaning solutions, wipe down the surface, or perform other maintenance tasks while the ball remains supported on the assembly. The ability to rotate the ball on the support may also allow for detailed visual inspection of the entire surface, potentially helping users identify areas that require attention or maintenance. In some cases, the support assembly may be designed to accommodate various sizes of bowling balls, providing a versatile solution for different types of equipment. The collapsible nature of the support assembly may offer advantages in terms of portability and storage, potentially making it a convenient tool for both casual and competitive bowlers.

The bowling ball support assembly 100 may be a collapsible and portable device designed to support a bowling ball, as shown in FIG. 45. In some cases, the bowling ball support assembly 100 may comprise a lower member assembly 102, an intermediate member assembly 104, and an upper member assembly 106. These member assemblies may be configured to interconnect via reciprocally shaped central notches to form a stable support structure.

The collapsible nature of the bowling ball support assembly 100 may allow for easy storage in a typical bowling bag. This feature may provide convenience for bowlers who wish to transport their own ball support device to different bowling locations.

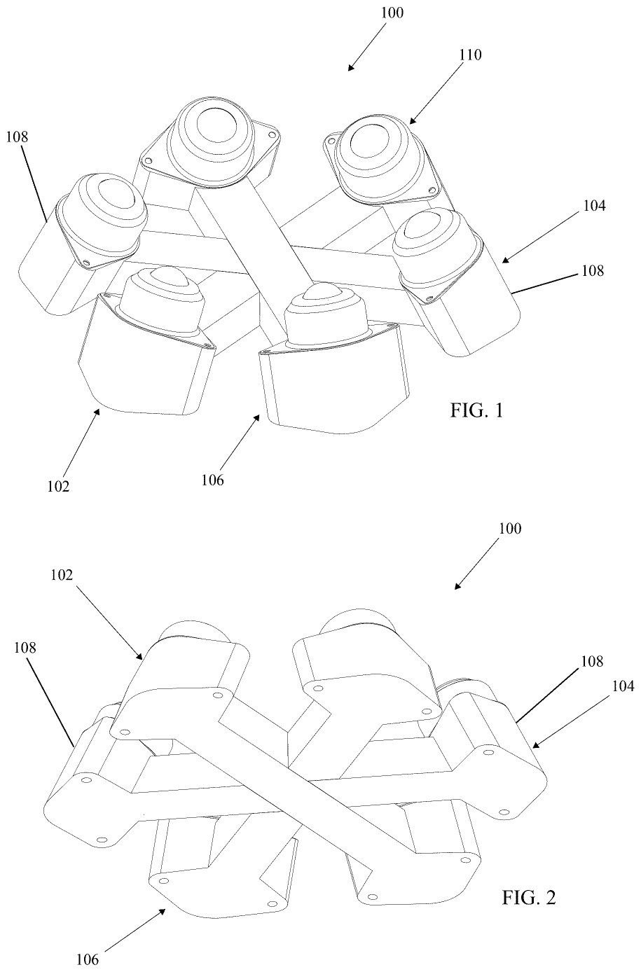

As shown in FIG. 1-FIG. 5, the bowling ball support assembly 100 may include multiple roller support platforms 108. In some implementations, six roller support platforms 108 may be arranged in a radial pattern around the center of the bowling ball support assembly 100. Each roller support platform 108 may support a roller ball bearing assembly 110. The roller ball bearing assemblies 110 may be arranged to provide rotational support for a bowling ball placed on the bowling ball support assembly 100.

The bowling ball support assembly 100 may be designed with a puzzle-like joinery at its center that incorporates a cross-directional locking system. This design may allow for easy assembly and disassembly of the lower member assembly 102, intermediate member assembly 104, and upper member assembly 106. The puzzle-like configuration with cross-directional locking may enable the bowling ball support assembly 100 to be collapsed for convenient storage and transport, while maintaining proper alignment and secure interconnection when reassembled.

In some cases, the interconnection of the lower member assembly 102, intermediate member assembly 104, and upper member assembly 106 may create a balanced and stable structure. This configuration may help maintain consistent spacing between the roller ball bearing assemblies 110, including roller balls 112, ensuring even support for a bowling ball placed on the bowling ball support assembly 100.

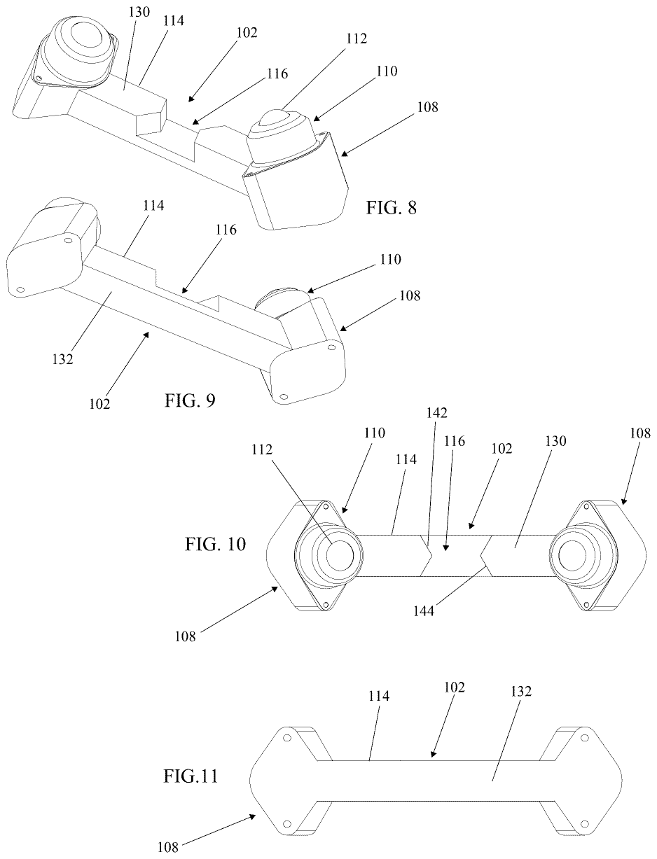

In some cases, the lower member assembly 102 of the bowling ball support assembly 100 may comprise a lateral support beam 114 having first and second ends. The lateral support beam 114 may extend between two roller support platforms 108, with each roller support platform 108 disposed at the first and second ends of the lateral support beam 114, respectively. This configuration is illustrated in FIGS. 8-12, which show various views of the lower member assembly 102.

As shown in FIG. 8, the lower member assembly 102 may include a roller ball bearing assembly 110 mounted on each roller support platform 108. Each roller ball bearing assembly 110 may comprise a roller ball 112, configured to provide rotational support for a bowling ball when the bowling ball support assembly 100 is fully assembled.

FIGS. 9 and 11 show the bottom surface 132 of the lower member assembly 102. The bottom surface 132 may extend along the length of the lateral support beam 114, providing a stable base for the lower member assembly 102 when it is placed on a flat surface.

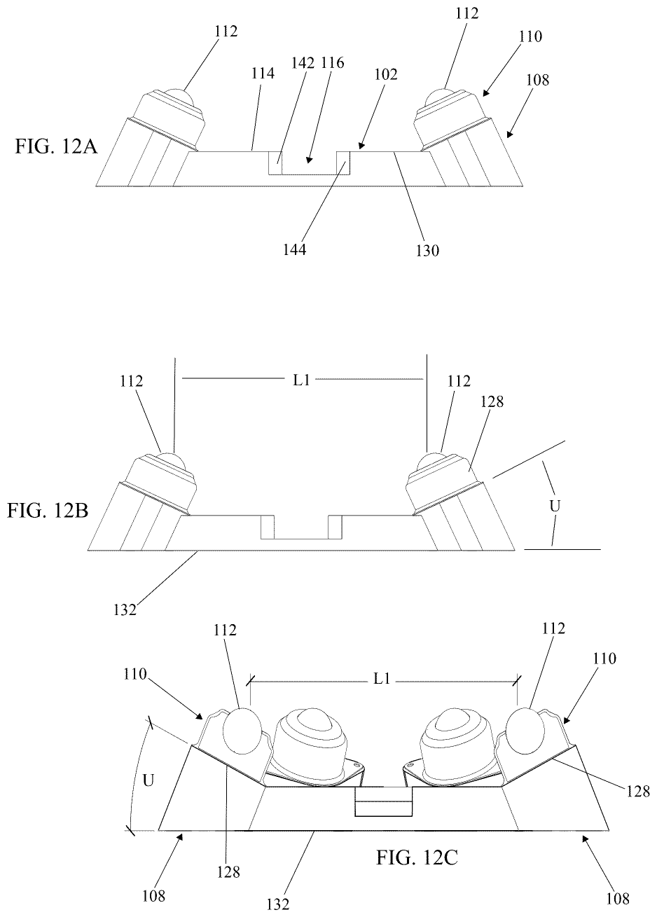

The lateral support beam 114 of the lower member assembly 102 may feature an upper shaped connecting notch 116, as depicted in FIGS. 8-10 and 12A-12C. In some implementations, the upper shaped connecting notch 116 may be formed along the top surface 130 of the lateral support beam 114. The upper shaped connecting notch 116 may provide a depth or channel within the lateral support beam 114 and may be defined by a first shaped wall 142 and a second shaped wall 144, as illustrated in FIG. 12A. The first shaped wall 142 and the second shaped wall 144 are mirrored triangular shapes that form the upper shaped connecting notch 116. This configuration may allow for interconnection with other components of the bowling ball support assembly 100, such as the intermediate member assembly 104 and the upper member assembly 106.

As illustrated in FIG. 12B and FIG. 12C, the lower member assembly 102 may be configured with specific dimensional relationships. A first length L1 defines the distance between the opposing roller balls 112. The first length L1 may represent the distance between opposing roller ball 112 contact points and may be consistent across all three member assemblies of the bowling ball support assembly 100. In some implementations, the first length L1 for the lower member assembly 102, intermediate member assembly 104, and upper member assembly 106 may be substantially equal to maintain proper alignment and balanced support when the assemblies are interconnected. The first length L1 may range between approximately 3 to 4 inches, and in some cases may be approximately 4 inches. This dimensional consistency may help ensure that the roller ball bearing assemblies 110 maintain uniform spacing when the bowling ball support assembly 100 is fully assembled, providing stable and balanced contact points for supporting a bowling ball.

The angle U, as depicted in FIGS. 12B and 12C, may define the inward tilt of the roller ball bearing assemblies 110 relative to the horizontal plane of the bowling ball support assembly 100. This angle U may be measured between the top attachment surface 128 and the bottom surface 132 of each member assembly. In some implementations, the angle U may be consistent across all three member assemblies—the lower member assembly 102, intermediate member assembly 104, and upper member assembly 106—to ensure uniform support characteristics when the bowling ball support assembly 100 is fully assembled.

Preferably, the inward angle U may range between approximately 0 to 30 degrees, providing flexibility in the degree of inward tilt for the roller ball bearing assemblies 110. In some cases, the inward angle U may be approximately 25 degrees for the bowling ball support assembly 100. This inward angle may help create a cup-like formation that cradles a bowling ball, potentially enhancing stability and preventing the ball from rolling off the support structure. The consistent angle U across all member assemblies may ensure that each roller ball 112 maintains the same orientation relative to the center of the bowling ball support assembly 100, contributing to balanced and uniform support for the bowling ball during use.

In some cases, the roller support platforms 108 of the lower member assembly 102 may be integrally formed with the lateral support beam 114, creating a single, unified structure. This design may enhance the stability and durability of the lower member assembly 102 while simplifying its manufacturing process.

The lower member assembly 102 may be configured to interconnect with the intermediate member assembly 104 and the upper member assembly 106 to form the complete bowling ball support assembly 100. The upper shaped connecting notch 116 may play a crucial role in this interconnection, allowing for a secure and precise fit with corresponding components of the other member assemblies.

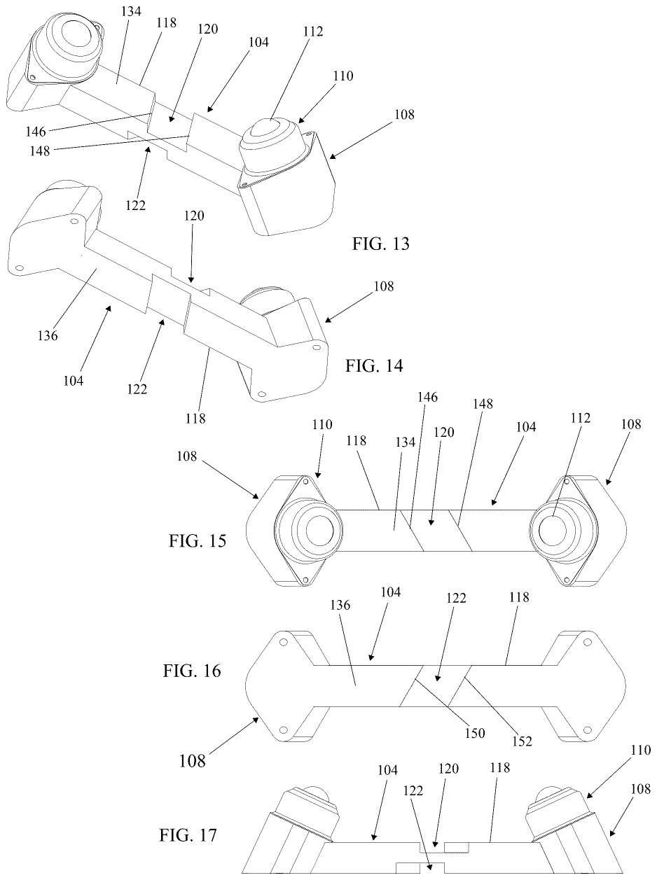

In some cases, the intermediate member assembly 104 of the bowling ball support assembly 100 may comprise a lateral support beam 118 having first and second ends. As illustrated in FIGS. 13-17, the lateral support beam 118 may extend between two roller support platforms 108, with each roller support platform 108 disposed at the first and second ends of the lateral support beam 118, respectively.

The intermediate member assembly 104 may include roller ball bearing assemblies 110 mounted on each roller support platform 108. Each roller ball bearing assembly 110 may comprise a roller ball 112, which may be configured to provide rotational support for a bowling ball when the bowling ball support assembly 100 is fully assembled.

As shown in FIG. 13 and FIG. 14, the lateral support beam 118 of the intermediate member assembly 104 may feature an upper shaped connecting notch 120 and a lower shaped connecting notch 122. In some implementations, the upper shaped connecting notch 120 may be formed along a top surface 134 of the lateral support beam 118, while the lower shaped connecting notch 122 may be formed along a bottom surface 136 of the lateral support beam 118.

The upper shaped connecting notch 120 may be formed as a channel or recess within the lateral support beam 118 and may be defined by a first shaped wall 146 and a second shaped wall 148, as illustrated in FIG. 13. The lower shaped connecting notch 122 may similarly be formed as a channel or recess within the lateral support beam 118 and may be defined by a third shaped wall 150 and a fourth shaped wall 152. These shaped connecting notches may allow the intermediate member assembly 104 to interconnect with other components of the bowling ball support assembly 100, including the lower member assembly 102 and the upper member assembly 106.

The lateral support beam 118 of the intermediate member assembly 104 may include both an upper shaped connecting notch 120 and a lower shaped connecting notch 122 that are configured as angled slots. In some implementations, the upper shaped connecting notch 120 may be oriented at an angle of approximately 60 degrees relative to the longitudinal axis of the intermediate member assembly 104. The lower shaped connecting notch 122 may be oriented at an opposing angle of approximately 60 degrees relative to the longitudinal axis of the intermediate member assembly 104. The upper shaped connecting notch 120 and the lower shaped connecting notch 122 may be positioned at opposing angles to each other, creating a configuration that facilitates secure interlocking with the other member assemblies.

FIGS. 14 and 16 show the bottom surface 136 of the intermediate member assembly 104. The bottom surface 136 may extend along the length of the lateral support beam 118, providing a stable connection point for the intermediate member assembly 104 when it is assembled with the lower member assembly 102.

In some cases, the roller support platforms 108 of the intermediate member assembly 104 may be integrally formed with the lateral support beam 118, creating a single, unified structure. This design may enhance the stability and durability of the intermediate member assembly 104 while simplifying its manufacturing process.

As depicted in FIG. 17, the profile of the roller ball bearing assemblies 110 mounted on the roller support platforms 108 may be visible. In some implementations, the roller balls 112 may be positioned at an inward angle towards the center of the bowling ball support assembly 100 when fully assembled. This inward orientation of the roller balls 112 may create a cup-like formation, providing optimal support for a bowling ball. The collective tilt of the roller balls 112 towards the center may help cradle the bowling ball, potentially enhancing stability and control during rotation. This configuration may allow the bowling ball to rest securely within the support structure while still permitting smooth movement for inspection or maintenance purposes.

The intermediate member assembly 104 may be configured to interconnect with both the lower member assembly 102 and the upper member assembly 106 to form the complete bowling ball support assembly 100. The upper shaped connecting notch 120 and the lower shaped connecting notch 122 may play a crucial role in this interconnection, allowing for a secure and precise fit with corresponding components of the other member assemblies.

The configuration of the intermediate member assembly 104, with its dual shaped connecting notches and strategically positioned roller support platforms 108, may contribute to the overall stability and functionality of the bowling ball support assembly 100. This design may allow for easy assembly and disassembly while maintaining proper alignment of all components when in use.

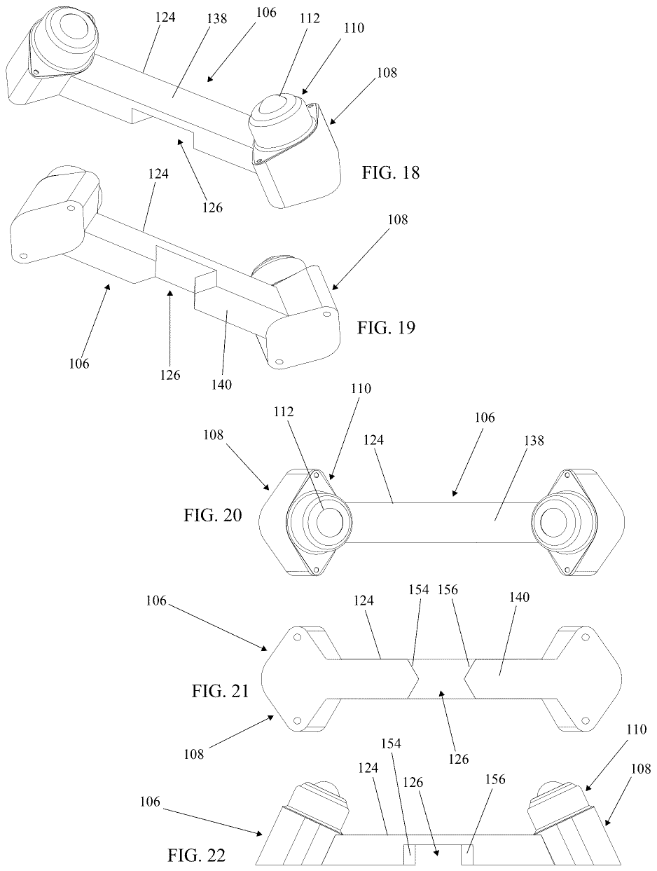

In some cases, the upper member assembly 106 of the bowling ball support assembly 100 may comprise a lateral support beam 124 having first and second ends. As illustrated in FIGS. 18-22, the lateral support beam 124 may extend between two roller support platforms 108, with each roller support platform 108 disposed at the first and second ends of the lateral support beam 124, respectively.

The upper member assembly 106 may include roller ball bearing assemblies 110 mounted on each roller support platform 108. Each roller ball bearing assembly 110 may comprise a roller ball 112 configured to provide rotational support for a bowling ball when the bowling ball support assembly 100 is fully assembled.

As shown in FIG. 18, the lateral support beam 124 of the upper member assembly 106 may feature a lower shaped connection notch 126. In some implementations, the lower shaped connection notch 126 may be formed along a bottom surface 140 of the lateral support beam 124. The lower shaped connection notch 126 may provide a depth within the lateral support beam 124 and may be defined by a first shaped wall 154 and a second shaped wall 156, as illustrated in FIG. 18. This configuration may allow for interconnection with other components of the bowling ball support assembly 100, such as the intermediate member assembly 104.

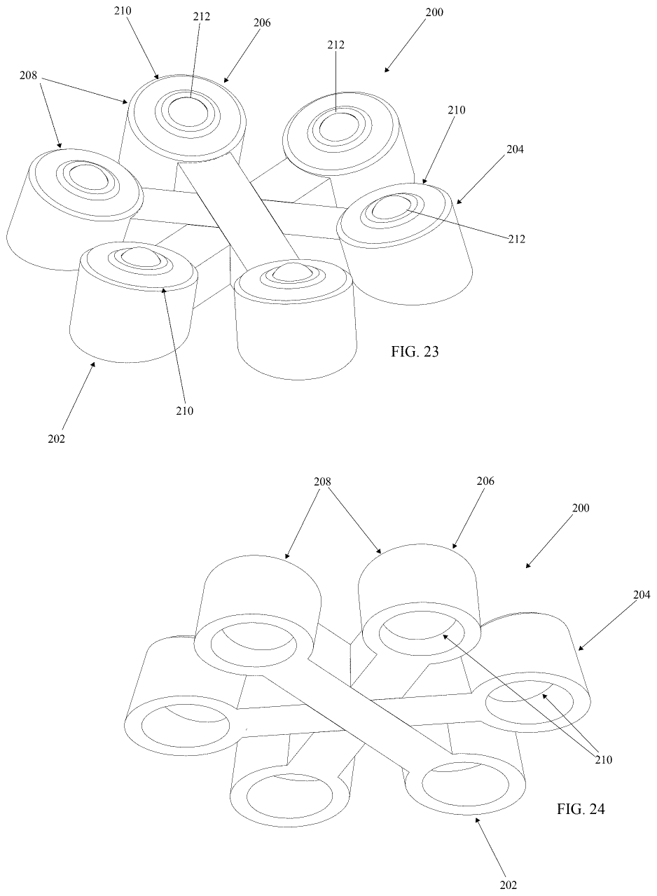

FIGS. 20 and 22 show the top surface 138 of the upper member assembly 106. The top surface 138 may extend along the length of the lateral support beam 124, providing a stable upper surface for the upper member assembly 106 when it is assembled with the other components of the bowling ball support assembly 100.

In some cases, the roller support platforms 108 of the upper member assembly 106 may be integrally formed with the lateral support beam 124, creating a single, unified structure. This design may enhance the stability and durability of the upper member assembly 106 while simplifying its manufacturing process.

The upper member assembly 106 may be configured to interconnect with the intermediate member assembly 104 to form the complete bowling ball support assembly 100. The lower shaped connection notch 126 may play a crucial role in this interconnection, allowing for a secure and precise fit with corresponding components of the intermediate member assembly 104.

As depicted in FIG. 19, the profile of the roller ball bearing assemblies 110 mounted on the roller support platforms 108 may be visible. In some implementations, the roller balls 112 may be positioned at an inward angle towards the center of the bowling ball support assembly 100 when fully assembled, providing optimal support for a bowling ball.

The configuration of the upper member assembly 106, with its lower shaped connection notch 126 and strategically positioned roller support platforms 108, may contribute to the overall stability and functionality of the bowling ball support assembly 100. This design may allow for easy assembly and disassembly while maintaining proper alignment of all components when in use.

By way of assembly, the lower member assembly 102, intermediate member assembly 104, and upper member assembly 106 of the bowling ball support assembly 100 may be configured to interconnect in a puzzle-like configuration. This configuration may allow for assembly and disassembly without the use of tools, providing convenience and portability to the user.

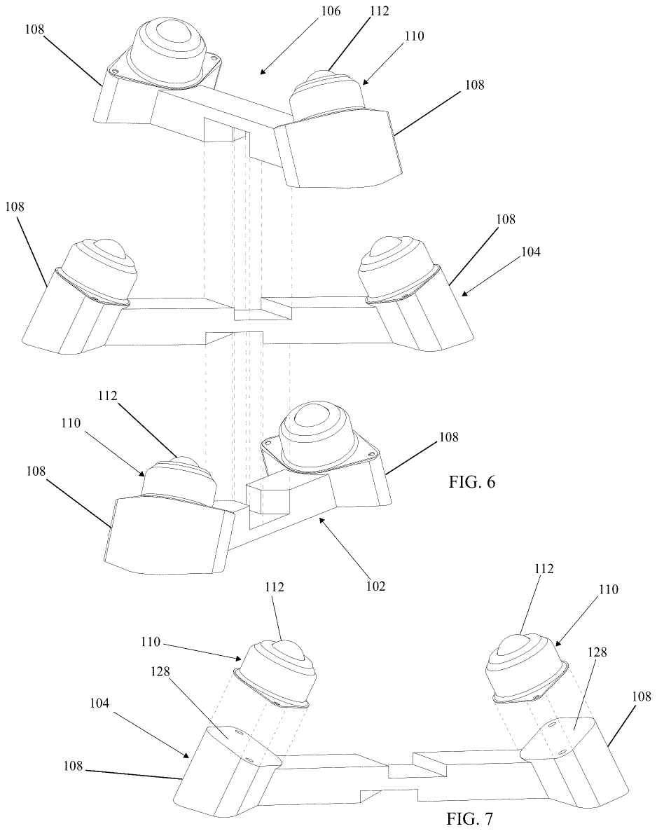

The interconnection of the member assemblies may be achieved through the engagement of shaped connecting notches on the lateral support beams of each assembly. As shown in FIG. 6, the lower member assembly 102 may include an upper shaped connecting notch 116 on its lateral support beam 114. The intermediate member assembly 104 may feature both an upper shaped connecting notch 120 and a lower shaped connecting notch 122 on its lateral support beam 118. The upper member assembly 106 may have a lower shaped connection notch 126 on its lateral support beam 124. In this configuration, the lower member assembly 102 and the upper member assembly 106 effectively sandwich the intermediate member assembly 104, creating a secure cross-directional locking system that maintains the bowling ball support assembly 100 in its assembled state while providing the roller support platforms 108 with their respective roller balls 112 in a stable radial support pattern.

In some implementations, the upper shaped connecting notch 116 of the lower member assembly 102 may engage with the lower shaped connecting notch 122 of the intermediate member assembly 104. Similarly, the upper shaped connecting notch 120 of the intermediate member assembly 104 may engage with the lower shaped connection notch 126 of the upper member assembly 106. This interlocking mechanism may create a stable and secure structure when the bowling ball support assembly 100 is fully assembled. Further, in some versions, the upper shaped connecting notch 116 of the lower member assembly 102 may connect with the lower shaped connection notch 126 of the upper member assembly 106, simultaneously securing the intermediate member assembly 104 therebetween as shown in FIG. 6.

The shaped connecting notches may be defined by specific wall configurations that contribute to the precise fit between the member assemblies. For example, the upper shaped connecting notch 116 of the lower member assembly 102 may be defined by a first shaped wall 142 and a second shaped wall 144. The lower shaped connecting notch 122 of the intermediate member assembly 104 may be defined by a third shaped wall 150 and a fourth shaped wall 152. These walls may be designed to correspond with each other, ensuring a snug fit when the assemblies are interconnected.

The angled configuration of the shaped connecting notches may facilitate the interlocking mechanism between the member assemblies. In some cases, the upper shaped connecting notch 120 of the intermediate member assembly 104 may be oriented at a specific angle relative to the longitudinal axis of the lateral support beam 118, while the lower shaped connecting notch 122 may be positioned at a corresponding but opposite angle. This angular relationship may allow the intermediate member assembly 104 to receive and secure both the lower member assembly 102 and the upper member assembly 106 simultaneously.

The angled slots may be designed to create a wedge-like engagement when the assemblies are brought together. In some implementations, the angular orientation of the upper shaped connecting notch 120 may complement the angle of the upper shaped connecting notch 116 of the lower member assembly 102, creating a secure mechanical connection. Similarly, the lower shaped connecting notch 122 may be angled to receive and lock with the lower shaped connection notch 126 of the upper member assembly 106.

The opposing angles of the upper shaped connecting notch 120 and lower shaped connecting notch 122 on the intermediate member assembly 104 may create a cross-directional locking system. This configuration may prevent the member assemblies from sliding apart once assembled, while still allowing for intentional disassembly when desired. The angled nature of these connecting features may also provide visual and tactile guidance during assembly, helping users align the components correctly.

In some cases, the depth and width of the angled slots may be precisely dimensioned to accommodate the corresponding shaped connecting notches of the lower member assembly 102 and upper member assembly 106. The angular geometry may distribute mechanical stress across the connection points, potentially enhancing the structural integrity of the assembled bowling ball support assembly 100.

FIG. 7 depicts a side exploded view of roller ball bearing assemblies 110 removed from the intermediate member assembly 104 top attachment surface 128 of each roller support platform 108. The roller ball bearing assemblies 110 include roller balls 112 positioned at specific angles, specifically inward towards the center of the intermediate member assembly 104. This exploded view demonstrates how the roller ball bearing assemblies 110 can be removed from their mounting positions on the roller support platforms 108, illustrating the modular nature of the bowling ball support assembly 100 components.

In some cases, the roller ball bearing assemblies 110 mounted on the roller support platforms 108 may have minor deflection capabilities. This feature may allow for easy assembly of the bowling ball support assembly 100 by providing some flexibility during the interconnection process. The minor deflection may also help accommodate slight variations in manufacturing tolerances, ensuring a smooth assembly process.

The roller ball bearing assemblies 110 may be designed with a specific interlocking tolerance precision. This precision may help maintain equal spacing between the roller ball bearing assemblies 110 when the bowling ball support assembly 100 is fully assembled. The consistent spacing may contribute to maintaining proper ball balance when a bowling ball is placed on the assembled support.

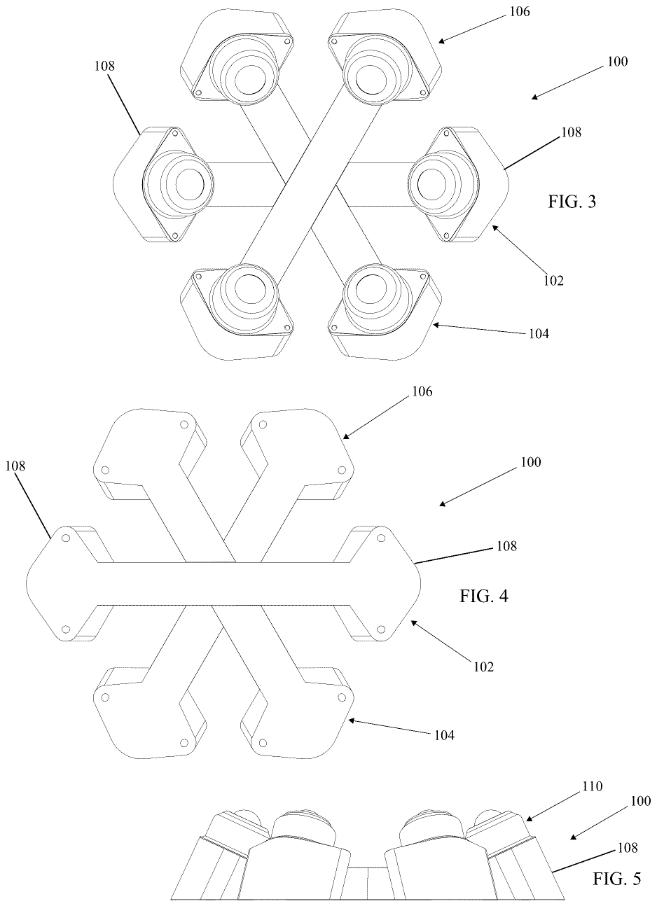

As shown in FIG. 3, FIG. 4, and FIG. 5, the interlocking mechanism of the member assemblies may result in a symmetrical arrangement of the roller ball bearing assemblies 110. This arrangement may ensure that the bowling ball is supported evenly across multiple contact points, providing stable and balanced support during use.

In some cases, the six roller ball bearing assemblies 110 may be positioned at specific radial intervals around the center of the bowling ball support assembly 100. The roller balls 112 may be arranged at approximately 60-degree intervals, creating an equidistant spacing pattern that provides balanced support for a bowling ball. This 60-degree separation may result from the three-member assembly configuration, where each of the lower member assembly 102, intermediate member assembly 104, and upper member assembly 106 contributes two roller ball bearing assemblies 110 positioned at opposite ends of their respective lateral support beams.

The radial positioning may be achieved through the angular orientation of the member assemblies relative to each other. In some implementations, the lower member assembly 102, intermediate member assembly 104, and upper member assembly 106 may be oriented at 120-degree intervals when viewed from above, with each assembly extending outward from the central connection point. This arrangement may position the roller support platforms 108 and their corresponding roller ball bearing assemblies 110 at the 60-degree intervals around the circumference.

The equidistant spacing of the roller balls 112 may contribute to uniform load distribution when a bowling ball is placed on the bowling ball support assembly 100. Each roller ball 112 may contact the bowling ball at approximately the same radial distance from the ball's center, potentially providing consistent support pressure across all contact points provided by each roller ball. This balanced contact pattern may help maintain the bowling ball's stability during rotation and may reduce the likelihood of uneven wear on the ball's surface.

In some cases, the 60-degree spacing may also facilitate smooth rotation of the bowling ball during use. The consistent angular separation between contact points may allow the bowling ball to roll smoothly from one roller ball 112 to the next as it rotates, potentially providing a more controlled and predictable movement pattern for inspection or maintenance activities.

The puzzle-like configuration and interlocking mechanism of the bowling ball support assembly 100 may allow for quick and easy assembly and disassembly. This feature may be particularly useful for users who need to transport the bowling ball support assembly 100 frequently, as the disassembled components may be more compact and easier to store in a bowling bag or other carrying case.

In some cases, the bowling ball support assembly 100 may be assembled through a step-by-step process that emphasizes its tool-free and puzzle-like assembly nature with cross-directional locking system. The assembly process may involve providing a lower member assembly 102, an intermediate member assembly 104, and an upper member assembly 106, as shown in FIG. 1, FIG. 2, and FIG. 6.

In some implementations, as illustrated in FIG. 7, the roller ball bearing assemblies 110 may be preinstalled on the top attachment surfaces 128 of the roller support platforms 108 prior to user assembly. This preinstallation may provide convenience for users by eliminating the need to separately mount individual roller ball bearing assemblies 110 during the assembly process. The roller ball bearing assemblies 110 may be factory-installed or pre-mounted on their respective top attachment surfaces 128, allowing users to focus on the primary assembly task of interconnecting the lower member assembly 102, intermediate member assembly 104, and upper member assembly 106 without handling small components.

As best shown in FIG. 6, the assembly process may begin by aligning the lower member assembly 102 and the intermediate member assembly 104. In some cases, the upper shaped connecting notch of the lower member assembly 102 may be engaged with the lower shaped connecting notch 122 of the intermediate member assembly 104. This engagement may create a secure connection between the two assemblies without the need for tools.

Next, the upper member assembly 106 may be aligned with the partially assembled structure. The lower shaped connection notch 126 of the upper member assembly 106 may be engaged with the upper shaped connecting notch 116 of the intermediate member assembly 104. This step may complete the interconnection of all three member assemblies, forming the stable support structure of the bowling ball support assembly 100.

The roller ball bearing assemblies 110 may include roller balls 112 that may be positioned to provide rotational support for the bowling ball. In some implementations, the roller balls 112 may be angled slightly inward towards the center of the bowling ball support assembly 100 to enhance stability and control.

The assembly process may be reversible, allowing for easy disassembly of the bowling ball support assembly 100. In some cases, the lower member assembly 102, intermediate member assembly 104, and upper member assembly 106 may be disconnected without the use of tools. This feature may facilitate convenient storage and transportation of the bowling ball support assembly 100.

The tool-free assembly and disassembly process may be achieved through the careful design of the shaped connecting notches and the interlocking tolerances of the components. The first shaped wall, second shaped wall, third shaped wall, and fourth shaped wall of the various shaped connecting notches may be configured to provide a secure fit while allowing for easy separation when needed.

In some implementations, the top surfaces and bottom surfaces of the lateral support beams may be designed to provide additional stability and alignment during the assembly process. These surfaces may help guide the user in correctly positioning and connecting the member assemblies.

The assembly process of the bowling ball support assembly 100 may be designed to be intuitive and user-friendly, allowing for quick setup and takedown without the need for specialized knowledge or tools. This feature may enhance the portability and convenience of the bowling ball support assembly 100 for users who frequently transport their bowling equipment.

In some cases, the bowling ball support assembly 100 may be configured to support and facilitate the rotation of a bowling ball 10. As shown in FIG. 1, FIG. 2, and FIG. 45, the bowling ball support assembly 100 may comprise multiple roller ball bearing assemblies 110 arranged in a radial pattern. This arrangement may provide balanced support for a bowling ball 10 when placed on the assembled bowling ball support assembly 100. As illustrated in FIG. 45, the bowling ball 10 rests securely on the bowling ball support assembly 100, with the roller ball bearing assemblies 110 positioned to make contact with the lower portion of the bowling ball 10 while allowing for rotational movement during inspection or maintenance purposes.

The roller ball bearing assemblies 110 may be mounted on the roller support platforms 108, which are integral parts of the lower member assembly 102, intermediate member assembly 104, and upper member assembly 106. As illustrated in FIG. 3, FIG. 4, and FIG. 5, the roller ball bearing assemblies 110 may be positioned at the ends of each member assembly, creating a symmetrical support structure for the bowling ball.

In some implementations, each roller ball bearing assembly 110 may comprise a roller ball 112. The roller balls 112 may be mounted at an inward angle towards the center of the bowling ball support assembly 100. This angled configuration may help to cradle the bowling ball and provide stable support while allowing for smooth rotation.

The arrangement of the roller ball bearing assemblies 110 may be designed to maintain consistent spacing between each roller ball 112. This consistent spacing may contribute to the balanced support of the bowling ball, ensuring that the weight of the ball is evenly distributed across multiple contact points.

When a bowling ball is placed on the assembled bowling ball support assembly 100, the roller balls 112 may make contact with the surface of the bowling ball. The inward angle of the roller balls 112 may allow the bowling ball to rest securely on the support while still permitting rotation. This configuration may enable users to easily rotate the bowling ball for inspection, cleaning, or maintenance purposes.

The rotational capability provided by the roller ball bearing assemblies 110 may allow users to access all areas of the bowling ball's surface without lifting the ball. In some cases, this feature may facilitate thorough cleaning of the bowling ball, as users can rotate the ball to expose different areas for cleaning while it remains supported by the bowling ball support assembly 100.

The balanced support provided by the evenly spaced roller ball bearing assemblies 110 may help prevent uneven wear or pressure on specific areas of the bowling ball. This may be particularly beneficial for maintaining the integrity of the bowling ball's surface over time.

In some implementations, the configuration of the roller ball bearing assemblies 110 and their positioning on the bowling ball support assembly 100 may allow for smooth, controlled rotation of the bowling ball. This may enable users to easily inspect the entire surface of the ball for any signs of wear, damage, or areas requiring maintenance.

The design of the bowling ball support assembly 100, with its interconnected lower member assembly 102, intermediate member assembly 104, and upper member assembly 106, may provide a stable platform for supporting the bowling ball during these rotational movements. The puzzle-like configuration of the assembled components may contribute to the overall stability of the structure, ensuring that the bowling ball remains securely supported even as it is rotated.

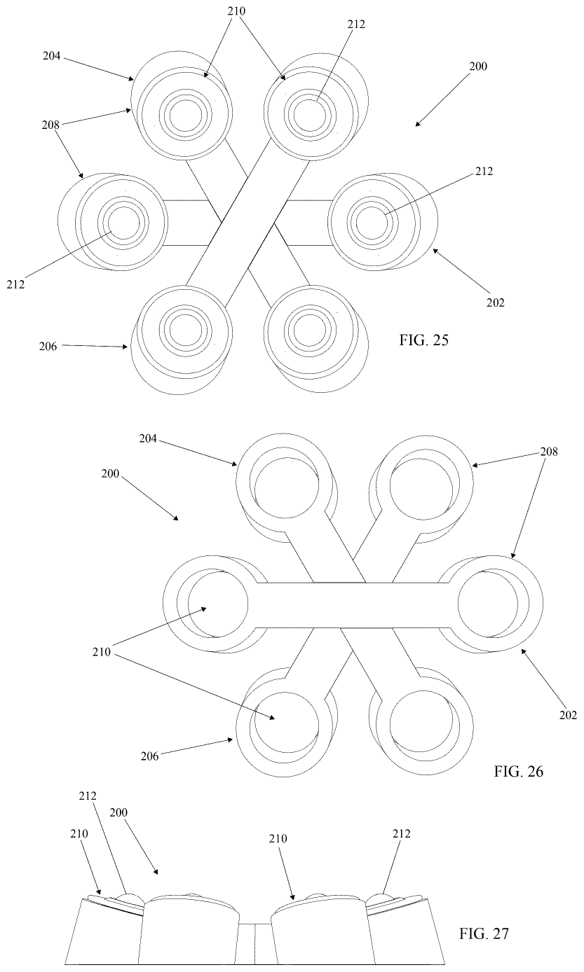

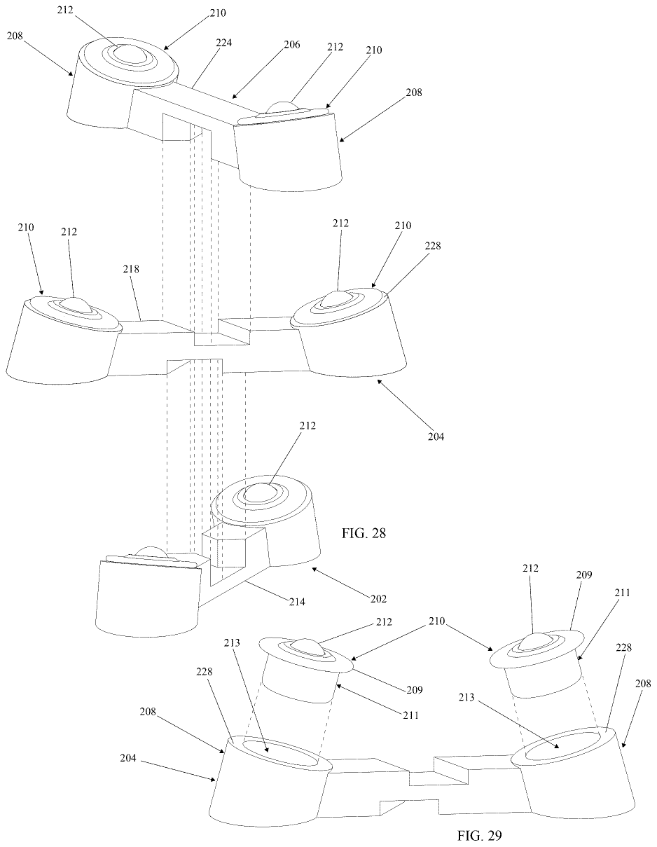

In some cases, an alternative embodiment of the bowling ball support assembly may be provided as bowling ball support assembly 200, as illustrated in FIGS. 23-28. The bowling ball support assembly 200 may share similar functional characteristics with the bowling ball support assembly 100 while incorporating design modifications that may enhance its performance or manufacturing efficiency. As shown in FIGS. 23 and 24, the bowling ball support assembly 200 may comprise a lower member assembly 202, an intermediate member assembly 204, and an upper member assembly 206, which may be configured to interconnect and form a stable support structure. The roller ball bearing assemblies 210 may be arranged in a radial pattern on roller support platforms 208, with each roller ball bearing assembly 210 including a roller ball 212. As depicted in FIGS. 25, 26, and 27, the bowling ball support assembly 200 may maintain the six-point support configuration while potentially offering alternative assembly characteristics or dimensional relationships.

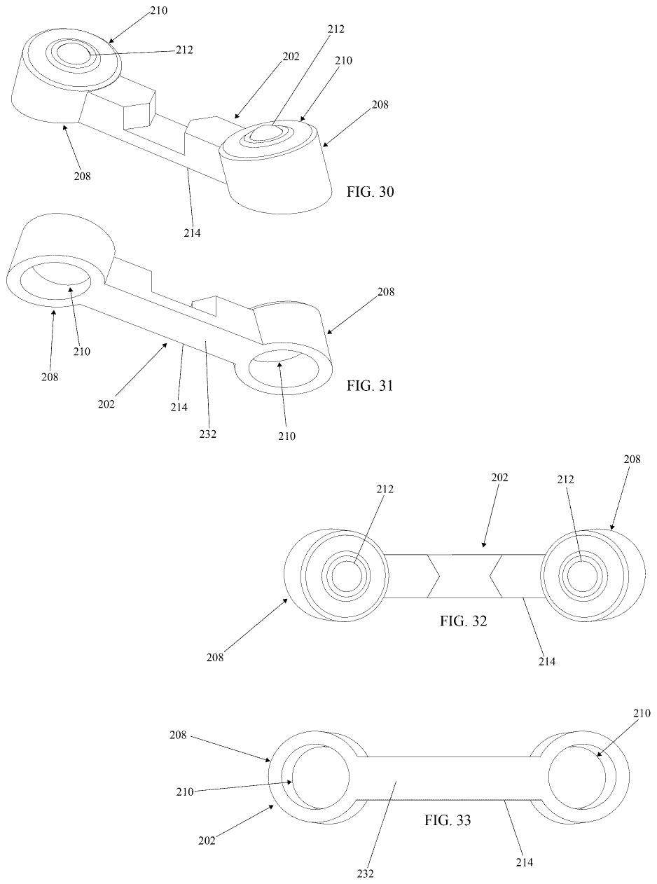

The bowling ball support assembly 200 may provide an alternative configuration that offers enhanced compactness and streamlined assembly characteristics. As illustrated in FIGS. 30-33, the lower member assembly 202 may comprise a lateral support beam 214 having first and second ends, with roller support platforms 208 disposed at the first and second ends of the lateral support beam 214. The lower member assembly 202 may include roller ball bearing assemblies 210 mounted within each roller support platform 208, with each roller ball bearing assembly 210 comprising a roller ball 212 configured to provide rotational support for a bowling ball when the bowling ball support assembly 200 is fully assembled.

As shown in FIGS. 30 and 32, the roller ball bearing assemblies 210 may be positioned at the terminal ends of the lower member assembly 202. The bottom support surface 232 may extend along the length of the lateral support beam 214, as depicted in FIGS. 31 and 33, providing a stable base for the lower member assembly 202 when placed on a flat surface. This configuration may allow the lower member assembly 202 to maintain proper alignment and stability during assembly and use.

The intermediate member assembly 204 of the bowling ball support assembly 200 may comprise a lateral support beam 218 having first and second ends, as illustrated in FIGS. 35-39. The lateral support beam 218 may extend between two roller support platforms 208, with each roller support platform 208 disposed at the first and second ends of the lateral support beam 218. The intermediate member assembly 204 may include roller ball bearing assemblies 210 mounted on each roller support platform 208, with each roller ball bearing assembly 210 comprising a roller ball 212.

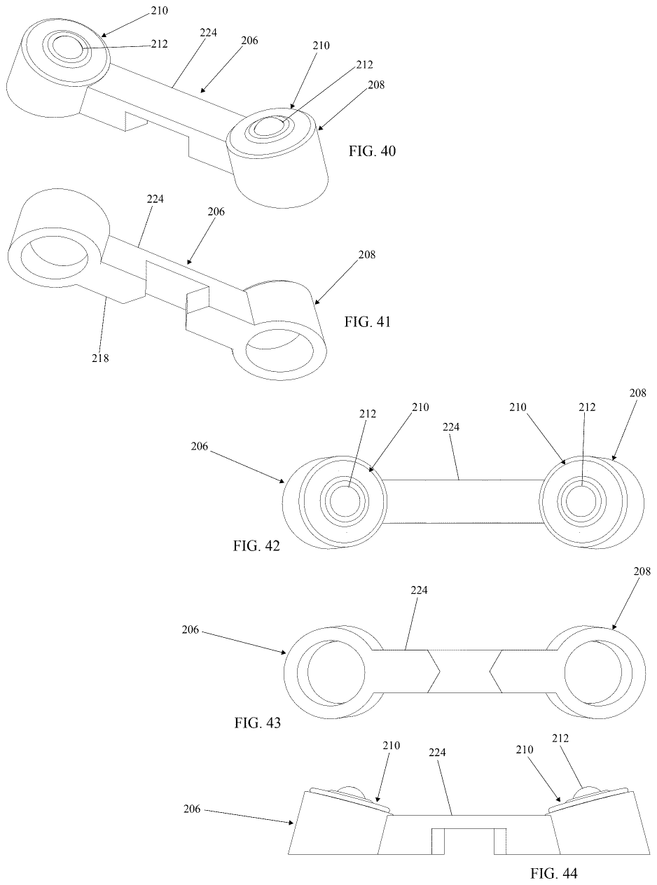

As depicted in FIGS. 35 and 37, the roller ball bearing assemblies 210 may be positioned to provide balanced support when the bowling ball support assembly 200 is fully assembled. The intermediate member assembly 204 may be configured to interconnect with both the lower member assembly 202 and the upper member assembly 206, forming a central connecting element in the overall structure of the bowling ball support assembly 200.

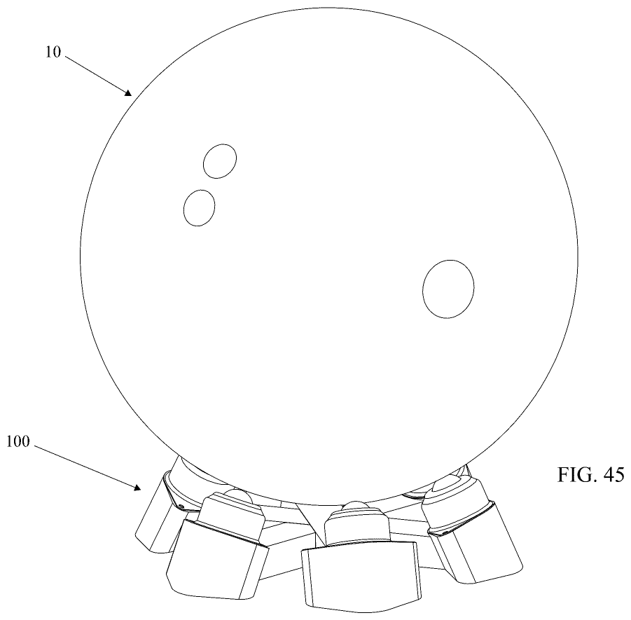

In some implementations, the upper member assembly 206 of the bowling ball support assembly 200 may comprise a lateral support beam 224 having first and second ends, as shown in FIGS. 40-44. The lateral support beam 224 may extend between two roller support platforms 208, with each roller support platform 208 disposed at the first and second ends of the lateral support beam 224. The upper member assembly 206 may include roller ball bearing assemblies 210 mounted on each roller support platform 208, with each roller ball bearing assembly 210 comprising a roller ball 212.

The roller ball bearing assemblies 210 of the bowling ball support assembly 200 may incorporate enhanced design features that distinguish them from the roller ball bearing assemblies 110 of the bowling ball support assembly 100. As illustrated in FIGS. 28 and 29, each roller ball bearing assembly 210 may comprise a cylindrical body 211 that may be seated within a cylindrical seat 213 formed in the roller support platform 208. The roller ball 212 may be positioned at the top of the cylindrical body 211, providing the contact surface for supporting a bowling ball.

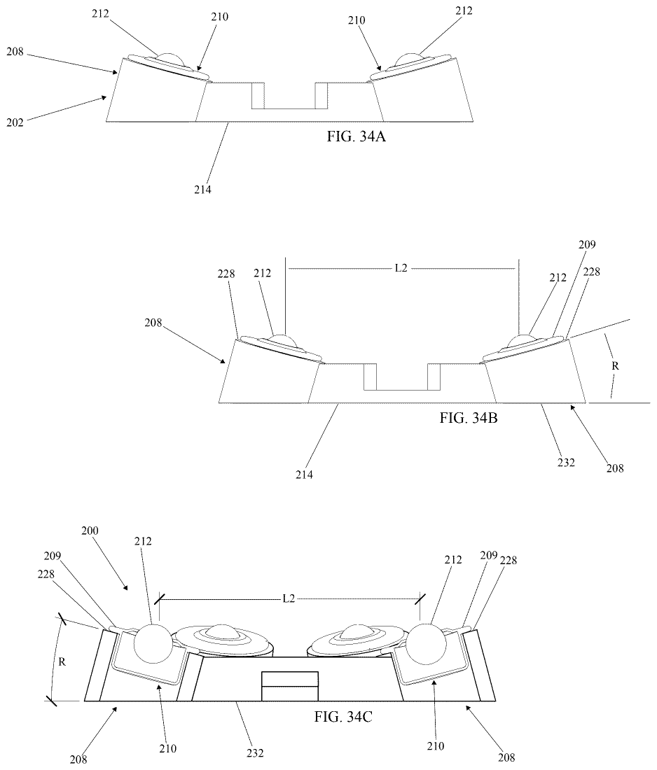

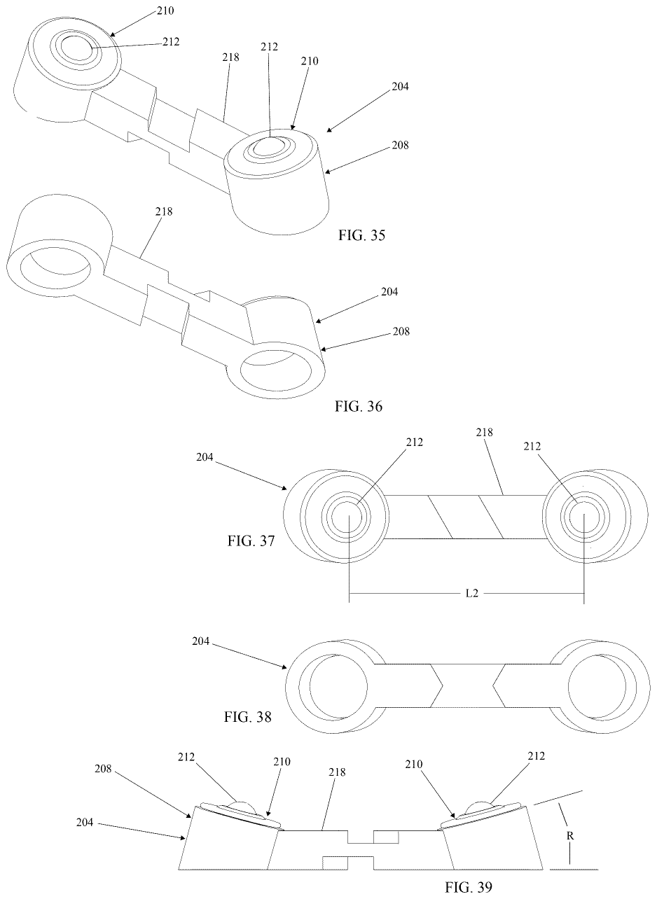

In some cases, the roller support platforms 208 may feature a top rim 228 that extends around the perimeter of each roller support platform 208, as shown in FIGS. 28, 29, and 34A-34C. The top rim 228 may define the top boundary of the cylindrical seat 213 and may provide a mounting surface for additional components. A cap 209 may be positioned over the top rim 228, as depicted in FIGS. 29 and 34A-34C, creating a finished appearance and potentially providing additional functionality for the roller ball bearing assembly 210.

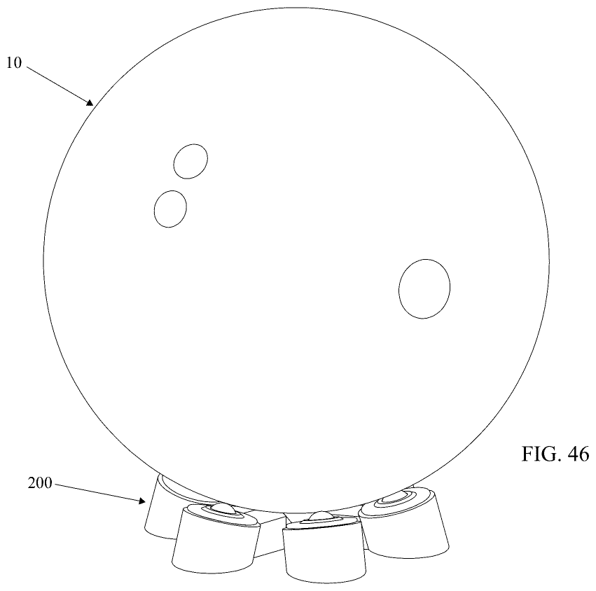

The embedded configuration of the roller ball bearing assemblies 210 within the roller support platforms 208 may provide a more compact profile compared to the bowling ball support assembly 100. As shown in FIG. 46, when a bowling ball 10 is placed on the bowling ball support assembly 200, the bowling ball 10 may sit at a lower level relative to the support structure, potentially offering improved stability and a lower center of gravity during use.

The dimensional relationships of the bowling ball support assembly 200 may be configured to maintain proper spacing and alignment of the roller ball bearing assemblies 210. As illustrated in FIG. 34B, a second length L2 may span the distance between the opposing contact points of the roller balls 212. Preferably, the length L2 is between 3-4 inches. In the illustrated version, the length L2 is 3 and ⅜^{th} inches. The angle R may be indicated between the top rim 228 or cap 209 and the bottom support surface 232, providing an inwardly angled positioning of the roller ball 212 for optimal interaction with a bowling ball. Preferably, the angle R is between 0 and 30 degrees. In the illustrated version, the angle R is approximately 14.75 degrees.

The assembly process of the bowling ball support assembly 200 may follow similar principles to the bowling ball support assembly 100, with the lower member assembly 202, intermediate member assembly 204, and upper member assembly 206 configured to interconnect in a tool-free manner. The enhanced design features of the roller ball bearing assemblies 210, including the cylindrical body 211, cylindrical seat 213, top rim 228, and cap 209, may provide improved durability and functionality while maintaining the ease of assembly and disassembly that characterizes the bowling ball support assembly design.

The bowling ball support assembly 200 may offer users an alternative configuration that provides similar functional benefits to the bowling ball support assembly 100 while incorporating design refinements that may enhance performance, manufacturing efficiency, or user experience. The embedded roller ball bearing assemblies 210 and compact profile may make the bowling ball support assembly 200 particularly suitable for applications where space efficiency and streamlined appearance are desired.

In some cases, the bowling ball support assembly may incorporate alternative configurations, materials, or additional features to enhance its functionality, durability, or user experience. These alternatives and variations may provide users with different options to suit their specific needs or preferences.

The roller ball bearing assemblies used in the bowling ball support assembly may be interchangeable. This feature may allow users to replace individual roller ball bearing assemblies as needed, without requiring replacement of the entire support structure. In some implementations, the roller ball bearing assemblies may be standard items that can be purchased at general hardware stores or online retailers. This availability may provide convenience for users who need to replace or upgrade their roller ball bearing assemblies.

In some cases, the bowling ball support assembly 100 may be designed to be easily disassembled and stored in a bowling bag. The lower member assembly 102, intermediate member assembly 104, and upper member assembly 106 may be configured to be compact when disassembled, allowing for efficient storage in standard bowling bags. This feature may enhance the portability of the bowling ball support assembly 100, making it convenient for users to transport their support device to different bowling locations.

The bowling ball support assembly 100 may be provided as a portable kit. In some implementations, the kit may include the disassembled components of the bowling ball support assembly 100, along with any necessary instructions for assembly and use. The portable kit configuration may allow for easy transportation and storage of the bowling ball support assembly 100 when not in use.

In some cases, alternative materials may be used for various components of the bowling ball support assembly 100. For example, the member assemblies may be constructed from lightweight yet durable materials such as high-strength plastics or aluminum alloys. These material choices may help reduce the overall weight of the bowling ball support assembly 100 while maintaining its structural integrity.

The roller support platforms may, in some implementations, feature adjustable height mechanisms. This feature may allow users to fine-tune the height of the roller ball 112 bearing assemblies to accommodate bowling balls of different sizes or to adjust the angle of support as desired.

The puzzle-like joinery of the member assemblies may, in some implementations, be enhanced with magnetic connectors. These magnetic connectors may provide additional stability to the assembled structure while still allowing for easy disassembly when needed.

In some cases, the roller ball 112 bearing assemblies may be designed with interchangeable roller balls. This feature may allow users to switch between different materials or surface textures for the roller balls, potentially providing varying levels of friction or support for different bowling ball types or conditions.

The roller support platforms may, in some implementations, incorporate shock-absorbing elements. These elements may help reduce vibration and provide a smoother rotation experience for the bowling ball, potentially enhancing the user's ability to inspect or clean the ball.

In some cases, the bowling ball support assembly 100 may be designed with customizable color options or interchangeable decorative panels. This feature may allow users to personalize their bowling ball support assembly to match their bowling equipment or personal preferences.

The portable kit version of the bowling ball support assembly may, in some implementations, include a dedicated carrying case. This case may be designed to securely hold all components of the disassembled support assembly, potentially providing additional protection during transportation and storage.

These alternatives and variations may provide users with a range of options to customize and enhance their bowling ball support assembly, potentially improving its functionality, durability, and overall user experience.

A number of implementations have been described. Nevertheless, it will be understood that various modifications may be made without departing from the spirit and scope of the disclosure. Accordingly, other implementations are within the scope of the following claims.

1. A bowling ball support assembly, comprising:
a first member assembly comprising a first lateral support beam having first and second ends;
a second member assembly comprising a second lateral support beam having first and second ends;
a third member assembly comprising a third lateral support beam having first and second ends;
wherein the first member assembly, second member assembly, and third member assembly are configured to interconnect to form a stable support structure; and
a plurality of roller ball bearing assemblies mounted on the first and second ends of the lateral support beams and arranged in a radial pattern to support a bowling ball.

2. The bowling ball support assembly of claim 1, wherein the first lateral support beam comprises an upper shaped connecting notch, the second lateral support beam comprises an upper shaped connecting notch and a lower shaped connecting notch, and the third lateral support beam comprises a lower shaped connecting notch.

3. The bowling ball support assembly of claim 2, wherein the upper shaped connecting notch of the first lateral support beam is configured to engage with the lower shaped connecting notch of the second lateral support beam, and the upper shaped connecting notch of the second lateral support beam is configured to engage with the lower shaped connecting notch of the third lateral support beam.

4. The bowling ball support assembly of claim 1, wherein each roller ball bearing assembly comprises a roller ball positioned at an inward angle towards a center of the bowling ball support assembly.

5. The bowling ball support assembly of claim 4, wherein the inward angle ranges between approximately 0 to 30 degrees.

6. The bowling ball support assembly of claim 1, wherein the roller ball bearing assemblies are arranged at approximately 60-degree intervals around the center of the bowling ball support assembly.

7. The bowling ball support assembly of claim 1, wherein the first member assembly, second member assembly, and third member assembly are configured to be disassembled and stored in a bowling bag.

8. The bowling ball support assembly of claim 4, wherein a distance between opposing roller balls ranges between approximately 3 to 4 inches.

9. A collapsible bowling ball support assembly, comprising:
a lower member assembly having a lateral support beam with an upper shaped connecting notch and roller support platforms at opposing ends;
an intermediate member assembly having a lateral support beam with an upper shaped connecting notch and a lower shaped connecting notch and roller support platforms at opposing ends;
an upper member assembly having a lateral support beam with a lower shaped connecting notch and roller support platforms at opposing ends;
wherein the shaped connecting notches are configured to engage with each other in a puzzle-like configuration to interconnect the assemblies without tools; and
roller ball bearing assemblies mounted on each roller support platform, each roller ball bearing assembly positioned at an inward angle towards a center of the bowling ball support assembly and comprising a roller ball.

10. The collapsible bowling ball support assembly of claim 9, wherein the upper shaped connecting notch of the lower member assembly is configured to engage with the lower shaped connecting notch of the intermediate member assembly, and the upper shaped connecting notch of the intermediate member assembly is configured to engage with the lower shaped connecting notch of the upper member assembly.

11. The collapsible bowling ball support assembly of claim 10, wherein the upper shaped connecting notch and the lower shaped connecting notch of the intermediate member assembly are angled with respect to each other to create a cross-directional locking system.

12. The collapsible bowling ball support assembly of claim 9, wherein each roller ball bearing assembly comprises a cylindrical body seated within a cylindrical seat formed in the roller support platform.

13. The collapsible bowling ball support assembly of claim 12, wherein each roller support platform comprises a top rim extending around a perimeter of the cylindrical seat, and a cap positioned over the top rim.

14. The collapsible bowling ball support assembly of claim 9, wherein the inward angle of each roller ball assembly ranges between approximately 0 to 30 degrees, and a distance between opposing roller balls ranges between approximately 3 to 4 inches.

15. A portable bowling ball support assembly, comprising:
a lower member assembly comprising a lateral support beam having an upper shaped connecting notch defined by first and second shaped walls, and roller support platforms at first and second ends of the lateral support beam;
an intermediate member assembly comprising a lateral support beam having an upper shaped connecting notch defined by first and second shaped walls and a lower shaped connecting notch defined by third and fourth shaped walls, and roller support platforms at first and second ends of the lateral support beam;
an upper member assembly comprising a lateral support beam having a lower shaped connecting notch defined by first and second shaped walls, and roller support platforms at first and second ends of the lateral support beam;
six roller ball bearing assemblies, each comprising a roller ball and mounted on a respective roller support platform at an inward angle of approximately 25 degrees towards a center of the assembly;
wherein the upper shaped connecting notch of the lower member assembly engages with the lower shaped connecting notch of the intermediate member assembly, and the upper shaped connecting notch of the intermediate member assembly engages with the lower shaped connecting notch of the upper member assembly to form a stable six-point radial support structure with roller balls spaced at approximately 60-degree intervals.

16. The portable bowling ball support assembly of claim 15, wherein the roller support platforms are integrally formed with their respective lateral support beams.

17. The portable bowling ball support assembly of claim 15, wherein each roller ball bearing assembly comprises a cylindrical body seated within a cylindrical seat formed in the roller support platform.

18. The portable bowling ball support assembly of claim 17, wherein each roller support platform comprises a top rim extending around a perimeter of the cylindrical seat.

19. The portable bowling ball support assembly of claim 18, further comprising a cap positioned over each top rim.

20. The portable bowling ball support assembly of claim 15, wherein a distance between opposing roller balls is approximately 3 and ⅜ inches.
